(19) United States
(12) Patent Application Publication
(10) Pub. No.: US 2021/0135546 A1
(43) Pub. Date: May 6, 2021

(54) Brushless Electrical Machine

(71) Applicant: Robert Bosch GmbH, Stuttgart (DE)

(72) Inventors: Wolfgang Sinz, Hergatz (DE); Lothar Detels, Burgberg (DE); Klaus Lerchenmueller, Rettenberg (DE); Mathias Kimmerle, Steinheim (DE); Axel Kiersten, Oberstenfeld (DE); Oliver Fuchs, Ilsfeld (DE)

(21) Appl. No.: 16/473,766

(22) PCT Filed: Nov. 16, 2017
(86) PCT No.: PCT/EP2017/079390

§ 371 Date: Jun. 26, 2019

(30) Foreign Application Priority Data
Dec. 29, 2016 (DE) 10 2016 226 293.9

(51) Int. Cl. H02K 11/215; G01D 5/14

(52) U.S. Cl. CPC H02K 11/215; G01D 5/145

(57) ABSTRACT

A brushless electrical machine, in particular a brushless direct current motor, includes a housing, a shaft rotatably mounted in the housing, at least one rotor mounted on the shaft, a stator fixed to the housing, and a rotor position-detecting device. The rotor position-detecting device operates in a contactless manner and is associated with the rotor. The rotor position-detecting device has a multipole magnet ring rotationally fixed on the shaft and at least one sensor which is sensitive to magnetic fields and which is radially associated with the outer periphery of the magnet ring.

The invention relates to a brushless electrical machine, in particular a brushless DC motor, comprising a housing, comprising at least one rotor which is arranged on a shaft which is rotatably mounted in the housing, and comprising a stator which is fixed to the housing, and also a rotor bearing detecting device which is associated with the rotor.

### PRIOR ART

Brushless electrical machines are already known in principle from the prior art. They are used in various ways and are also employed in motor vehicle construction in particular. In this case, they are used, for example, as actuating motors, drive motors or the like. Brushless machines have the advantage that mechanical commutation is dispensed with, as a result of which mechanical wear is reduced. However, in order to be able to correctly actuate a machine of this kind, it is important to know the rotor position or the rotation angle of the rotor. Rotor position detecting devices, which operate without contact, are preferably used for this purpose. In this case, a magnetic field encoder is usually arranged on the end side of the shaft of the rotor and a magnetic field-sensitive sensor is arranged axially or, in a continuation of the shaft, facing its end side. Depending on the rotation position of the shaft, the recorded magnetic field changes, as a result of which the rotation angle position or the rotor position of the rotor can be determined by means of a corresponding evaluation of the sensor output signal.

### DISCLOSURE OF THE INVENTION

The machine according to the invention having the features of claim 1 has the advantage that the rotor position can be recorded in a particularly accurate and rapid manner and that advantages in respect of installation space are created. To this end, provision is made according to the invention for the rotor detecting device to have a multipole magnet ring, which is arranged or can be arranged in a rotationally fixed manner on the shaft, and at least one magnetic field-sensitive sensor which is radially associated with the outer periphery of the magnet ring. Therefore, the invention makes provision for the magnetic field-sensitive sensor to not be associated with the shaft and the magnetic field encoder at the end side or axially, but rather to be radially associated with the magnet ring, so that the sensor is ultimately arranged axially level with the shaft. As a result, the machine can be designed to be axially shorter overall. Furthermore, the rotor position detecting device can be arranged, in principle, on any desired axial section of the shaft, and therefore, for example, even between a shaft bearing and the rotor which is arranged on the shaft. This creates freedom in respect of design which allows optimum use and optimum design of the electrical machine depending on the existing framework conditions.

According to a preferred development of the invention, provision is made for the sensor to be designed as a TMR sensor. TMR sensors operate on the basis of the principle of magnetic tunnel resistance (TMR). A sensor of this kind is manufactured using thin-film technology and allows highly accurate magnetic field sensing in a small space.

Furthermore, provision is preferably made for the sensor to be oriented in such a way that it a measuring direction for recording magnetic fields is oriented at an angle differing from a perpendicular orientation in relation to the rotation axis of the magnet ring. Here, the measuring direction is understood to mean the main axis of the main measuring direction of the sensor. The inclined orientation of the main axis or of the measuring direction of the sensor has the effect that a homogeneous signal is produced at the signal output of the sensor. In particular, the TMR sensor has a plurality of measuring elements which are arranged on a measuring plate in a manner interconnected with one another in a TMR bridge. In this case, the perpendicular in relation to the measuring plate represents the main measuring direction or main axis of the measuring direction. In this case, the measuring plate is then therefore arranged in such a way that its perpendicular differs from a precisely radial orientation.

In particular, provision is preferably made for the magnet ring to have a large number of magnet poles with alternating magnetic field orientation distributed over the periphery, which magnet poles are arranged distributed uniformly over the periphery in particular. Here, a large number of magnet poles is understood to mean, in particular, a number of at least four, in particular six, eight, ten, twelve or more magnet poles. The more magnet poles there are, the more accurate a determination of the rotor position.

Furthermore, provision is preferably made for the magnet ring to be arranged on a magnet ring carrier which is pushed onto the shaft. Therefore, the magnet ring is not fastened directly to the shaft but rather held on said shaft by the magnet ring carrier. This has the effect that the magnet ring can be mounted on the shaft in a simple manner and in a short time. Furthermore, highly accurate arrangement of the magnet ring on the shaft is possible, wherein the same magnet ring can be arranged on shafts or shaft sections of a shaft of different design by the magnet ring carrier.

According to a preferred development of the invention, provision is made for the magnet ring carrier to have a burst-protection means which surrounds the magnet ring at its outer periphery. To this end, the magnet ring carrier has, in particular, a casing wall which surrounds or encloses the magnet ring at its outer periphery. The burst-protection means has the effect that, if the magnet ring were to break, no parts of the magnet ring will be flung into the surrounding area at high speed. As a result, the electrical machine is protected against further damage. In addition, the magnet ring itself is protected against external influences by the burst-protection means, so that the risk of damage to the magnet ring itself is likewise reduced.

In particular, provision is made for the magnet ring carrier to be designed in a cup-like manner. As a result, the burst-protection means is automatically formed by the casing wall. According to a preferred development of the invention, provision is made for the magnet ring carrier to also have an internal casing wall of the cup-like magnet ring carrier, which internal casing wall is associated with the inner periphery of the magnet ring, so that the magnet ring is protected or supported on the inside by the inner casing wall of the magnet ring carrier. This ensures simple arrangement of the magnet ring on the magnet ring carrier.

According to a preferred development of the invention, provision is also made for the magnet ring carrier to form at least one interlocking rotation-prevention means with the shaft. This ensures that the magnet ring is arranged on the shaft in a rotationally fixed manner in a simple way. The rotation-prevention means is formed, for example, by a groove, which extends axially or in the longitudinal direction, on the outer periphery of the shaft and a driver projection which engages into the groove and is fixedly connected to the magnet ring carrier or, in particular, is integrally formed with said magnet ring carrier. In particular, a plurality of groove/driver projection pairs or rotation-prevention means of said kind are formed in a manner distributed over the periphery of the magnet ring carrier and the shaft in order to ensure the magnet ring carrier is carried along in rotation and has a variable orientation on the shaft.

The invention will be explained in more detail below with reference to the drawing, in which

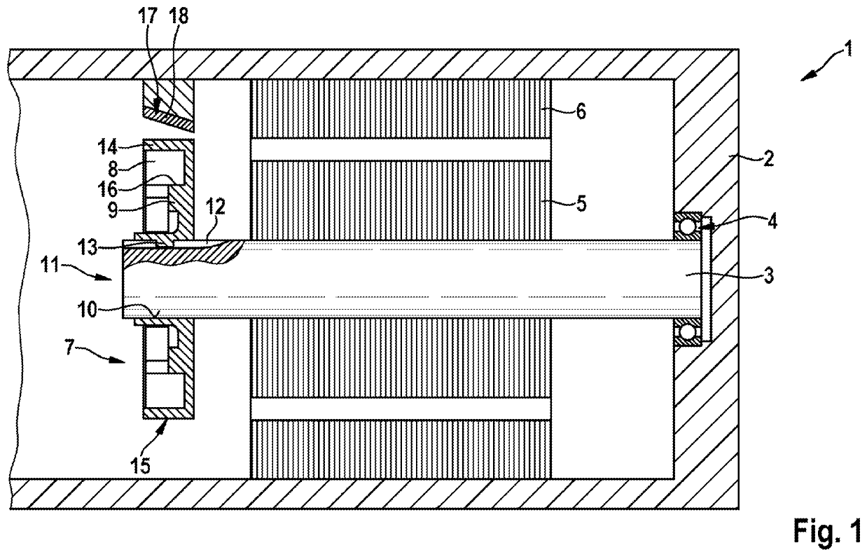

FIG. 1 shows a simplified illustration of a longitudinal section through a brushless electrical machine,

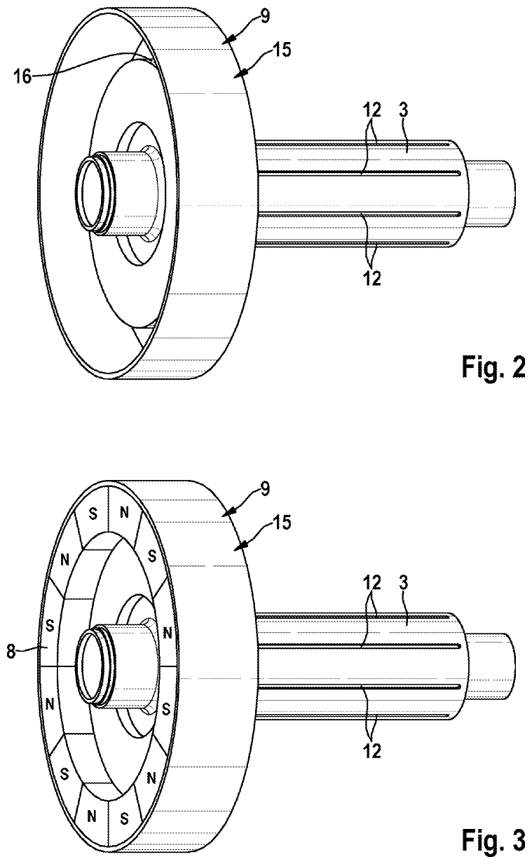

FIG. 2 shows a perspective illustration of a view of a detail of the machine, and

FIG. 3 shows a perspective illustration of a second view of a detail of the machine.

FIG. 1 shows a simplified illustration of a longitudinal section through a brushless DC motor 1 which has a housing 2 in which a shaft 3 is rotatably mounted. In the present case, bearing of the shaft 3 is realized by a plurality of roller body bearings 4, only one of which is shown here by way of example.

A rotor 5 is arranged on the shaft 3 and is connected to the shaft 3 in a rotationally fixed manner. A stator 6 is coaxially associated with the rotor 5, said stator being arranged fixed to the housing or on the housing 2. By virtue of a suitable power electronics system, current can be applied to the stator 6 or to a coil of the stator 6 in order to set the rotor 5 in rotation with the prespecifiable torque. In order to be able to correctly actuate the coil of the stator 6, a rotor position detecting device 7 is provided, by means of which the current rotation angle position of the rotor 5 with respect to the stator 6 is monitored.

The rotor position detecting device 7 has a magnet ring 8 which has a large number of magnet poles N and S which are arranged distributed uniformly over its periphery and with an alternating magnetic field orientation. The magnet ring 8 is held on a magnet ring carrier 9. The magnet ring carrier 9 is likewise of annular design and therefore has a central passage opening 10 by way of which the magnet ring carrier 9 is pushed onto the shaft 3. In particular, the inside diameter of the opening 10 and the outside diameter 3 in the push-on region are designed in such a way that a virtually play-free fit or a press-fit is produced during the push-on operation in order to ensure that the magnet ring carrier 9 is securely held on the shaft 3.

In addition, provision is preferably made for at least one rotation-prevention means 11 to be formed between the magnet ring carrier 9 and the shaft 3. According to the present exemplary embodiment, said rotation-prevention means is formed by a groove 2, which is formed in the outer periphery of the shaft 3, and a driver projection 13, which is formed by the magnet ring carrier 9 and engages into or is situated in the groove 12. In this case, the driver projection 13 is situated in the groove 12 without play, in particular as seen in the peripheral direction. A plurality of rotation-prevention means 11 of this kind are advantageously designed or arranged distributed over the periphery of the magnet ring carrier 9 and the shaft 3. In particular, provision is made for the shaft 3 to have a plurality of grooves 12, so that the magnet ring carrier 9 can be pushed onto the shaft 3 in several rotation angle positions. In this case, the respective groove 12 is designed to be axially open, so that the magnet ring carrier 9, by way of the driver projection 13, can be easily pushed onto the shaft 3.

Furthermore, the magnet ring carrier 9 has an outer casing wall 14 which surrounds the magnet ring 8 at its outer periphery. The outer casing wall 14 forms a burst-protection means 15 for the magnet ring 8 in this respect. If said magnet ring were to be damaged and break during operation, individual parts of the magnet ring are captured by the burst-protection means 15 and are not flung into the interior of the housing 2 where they could cause further damage.

Furthermore, the magnet ring carrier 9 has an inner casing wall 16 which surrounds the inner periphery of the magnet ring 8 at least axially in regions, so that the magnet ring 8 is held on the magnet ring carrier 9 between the casing outer wall 14 and the casing wall 16. As a result, the magnet ring carrier 9 acquires overall a cup-like shape into which the magnet ring 8 can be easily axially inserted.

Furthermore, a magnetic field-sensitive sensor 17 is arranged on the housing 2 and radially associated with the outer periphery of the magnet ring 8. The sensor 17 therefore lies axially level with the magnet ring 8 in the housing 2. In this case, the sensor 17 is designed as a TMR sensor with a plurality of measuring elements which are arranged next to one another on a measuring plate 18 and are interconnected to form an electrical bridge. In this case, the measuring plate 18 is oriented at an angle differing from 90° in relation to the rotation axis of the magnet ring 8, so that the main measuring direction or recording direction of the sensor 17 is oriented obliquely in relation to the rotation axis of the magnet ring 8.

In addition, FIG. 2 shows a perspective view of a detail of the shaft 3 with the magnet ring carrier 9 arranged on it. The cup shape of the magnet ring carrier 9 can be clearly seen in said figure. According to the present exemplary embodiment, the shaft 3 has a plurality of grooves 12 which extend over a wide axial region of the shaft 3, so that the magnet ring carrier 9 can be freely arranged on the shaft 3 in a large number of different axial positions. For example, the magnet ring carrier 9 can be arranged between the rotor 5 and a further roller body bearing or on that side of the roller body bearing which is averted from the rotor 5.

FIG. 3 shows a further perspective partial view of the shaft 3 with the magnet ring carrier 9 from FIG. 2 arranged on it, wherein the magnet ring 8 is now inserted in the magnet ring carrier 9. FIG. 3 shows, by way of example, a subdivision of the magnet ring 8 into a large number of magnet poles N and S.

The magnet ring 8 can be embodied with a different number of poles in principle. In this case, any magnetic materials can be used as the magnet material, such as rare-earth magnets, in particular sintered or plastic-bonded, hard ferrites or the like for example.

The sensor 17 detects the strength of the magnetic field which is generated by the magnet ring 8 and a computer unit or evaluation unit which is coupled to the sensor 17 calculates the current rotation angle position of the shaft 3, and therefore the rotor angle position of the rotor 5, depending on the detected magnetic field strength. Current is then applied to the coil of the stator 6, and in particular said coil is electrically commutated, depending on the determined rotor angle positions.

1. A brushless electrical machine, comprising:
a housing;
a shaft rotatably mounted in the housing;
at least one rotor arranged on the shaft;
a stator fixed to the housing; and
a rotor position detecting device spaced apart from the at least one rotor so as to operate without contacting the at least one rotor, the rotor position detecting device including a multipole magnet ring arranged in a rotationally fixed manner on the shaft, and further including at least one magnetic field-sensitive sensor radially associated with an outer periphery of the multipole magnet ring.

2. The brushless electrical machine as claimed in claim 1, wherein the at least one magnetic field-sensitive sensor includes a TMR sensor.

3. The brushless electrical machine as claimed in claim 1, wherein the at least one magnetic field-sensitive sensor is oriented in such a way that a measuring direction for recording magnetic fields is oriented at an angle differing from a perpendicular direction in relation to a rotation axis of the multipole magnet ring.

4. The brushless electrical machine as claimed in claim 1, wherein the multipole magnet ring includes a plurality of magnet poles distributed over the outer periphery of the multipole magnet ring.

5. The brushless electrical machine as claimed in claim 1, further comprising:
a magnet ring carrier arranged on the shaft,
wherein the magnet ring is arranged on the magnet ring carrier.

6. The brushless electrical machine as claimed in claim 5, wherein the magnet ring carrier includes a burst-protection member surrounding the multipole magnet ring at the outer periphery of the multipole magnet ring.

7. The brushless electrical machine as claimed in claim 5, wherein the magnet ring carrier is configured in a cup-like manner.

8. The brushless electrical machine as claimed in claim 5, wherein the magnet ring carrier defines at least one interlocking rotation-prevention element with the shaft.

9. The brushless electrical machine as claimed in claim 1, wherein the brushless electrical machine is a brushless DC motor.

10. The brushless electrical machine as claimed in claim 4, wherein the magnet poles are distributed uniformly over the outer periphery of the multipole magnet ring.
